(19) United States
(12) Patent Application Publication
(10) Pub. No.: US 2023/0118730 A1
(43) Pub. Date: Apr. 20, 2023

(54) SYSTEMS AND METHODS FOR FILTERING NETWORK COMMUNICATIONS WITH A DEMILITARIZED ZONE

(71) Applicant: Saudi Arabian Oil Company, Dhahran (SA)

(72) Inventors: Abdullah A. Dossary, Khobar (SA); Adel S. Al Sammahy, Khobar (SA); Mostafa H. Al Amer, Dammam (SA)

(73) Assignee: Saudi Arabian Oil Company, Dhahran (SA)

(21) Appl. No.: 17/503,818

(22) Filed: Oct. 18, 2021

(51) Int. Cl. H04L 29/06

(52) U.S. Cl. CPC H04L 63/0209; H04L 63/164; H04L 63/166; H04L 63/168; H04L 63/0236

(57) ABSTRACT

Systems and methods for filtering data network communications using a demilitarized zone (DMZ) are provided. One embodiment includes receiving a first communication from an untrusted network for delivery to a computing device on a trusted network, where the first communication includes a payload and a header. In some embodiments, the method includes filtering the header to determine an internet protocol (IP) address of a remote computing device of the first communication and to determine whether the IP address is associated with an approved remote computing device. Some embodiments include determining whether the header identifies an approved TCP port and/or an approved UDP port. Some embodiments include terminating transmission of the first communication and examining the first communication to determine whether the first communication includes malware. Embodiments may also include maintaining legitimate session records and ensuring the first communication originated from a trusted data source.

### TECHNICAL FIELD

Embodiments described herein generally relate to systems and methods for filtering network communications with a demilitarized zone and, more specifically, to utilizing a layered approach for filtering network communications.

### BACKGROUND

Computer and network security is an important and ever-evolving part of the digital age. Currently there are several different layers of protection that can protect a computer or network from various types of malware and other security breaches. Antivirus software has been employed for many years, as have firewalls. Networks with a demilitarized zone (DMZ) have more recently been employed to secure a first portion of a network, while allowing a second portion of a network (the DMZ) to communicate with one or more untrusted networks.

While DMZs have proven very useful, the structure itself is typically modeled as one or more firewalls that divide the DMZ into a separate network infrastructure than the trusted network. Specifically, the DMZ may be configured such that the computing devices within the DMZ have limited connectivity to computing devices in the internal network, as the DMZ is not as secure as the internal network. Communication between computing devices in the DMZ and computing devices on a remote, untrusted network, may also be restricted to provide some level of security to the DMZ. Thus, the computing devices within the DMZ may communicate with devices within the trusted network and the untrusted network.

While such a configuration may be useful, the security of the DMZ may be lacking and the overall functionality and speed of the networks may be hindered. Thus, a need exists in the industry for filtering network communications with a DMZ.

### SUMMARY

Systems and methods for filtering data network communications using a demilitarized zone (DMZ) are provided. One embodiment includes receiving a first communication from an untrusted network for delivery to a computing device on a trusted network, where the first communication includes a payload and a header. In some embodiments, the method includes filtering the header to determine an internet protocol (IP) address of a remote computing device of the first communication and to determine whether the IP address is associated with an approved remote computing device. Some embodiments include determining whether the header identifies an approved TCP port and/or an approved UDP port. Some embodiments include terminating transmission of the first communication and examining the first communication to determine whether the first communication includes malware. Embodiments may also include maintaining legitimate session records and ensuring the first communication originated from a trusted data source.

In another embodiment, a system for filtering data network communications using a demilitarized zone (DMZ) includes a trusted network that includes a computing device, a DMZ that includes a hosting device, and security infrastructure. The security infrastructure may include logic, that when executed by a processor, causes the security infrastructure to receive a first communication from an untrusted network for delivery to the computing device on the trusted network, where the first communication includes a payload and a header. The logic may be further configured to cause the system to perform a first level filtering of the first communication. The first level filtering includes a first open systems interconnection (OSI) layer 3 filtering of the header to determine an internet protocol (IP) address of a remote computing device of the first communication and to determine whether the IP address is associated with an approved remote computing device. In some embodiments, the logic causes the system to perform a second level filtering of the first communication, where the second level filtering includes a first OSI layer 4 analysis of at least one of the following in the header: a transmission control protocol (TCP) port or a user datagram protocol (UDP) port, to determine whether the header identifies at least one of the following: an approved TCP port or an approved UDP port. In some embodiments, the logic causes the system to perform a third level filtering of the first communication, where the third level filtering includes an OSI layer 5 through layer 7 inspection, and where the third level filtering includes terminating transmission of the first communication and examining the first communication to determine whether the first communication includes malware. Some embodiments may include logic that causes the system to perform a fourth level filtering of the first communication, where the fourth level filtering includes a second OSI layer 4 analysis, where the fourth level filtering includes maintaining legitimate session records and ensuring the first communication originated from a trusted data source. The logic may cause the system to perform a fifth level filtering of the first communication, where the fifth level filtering includes a second OSI layer 3 filtering, where the fifth level filtering includes ensuring proper handling of the first communication toward the computing device. In response to determining that the first communication passes the first level filtering, the second level filtering, the third level filtering, the fourth level filtering, and the fifth level filtering, the logic may cause the system to pass the first communication to the computing device on the trusted network.

In yet another embodiment, a system for filtering data network communications using a demilitarized zone (DMZ) includes security infrastructure. The security infrastructure includes logic, that when executed by a processor, causes the security infrastructure to receive a first communication from an untrusted network for delivery to a computing device on a trusted network, where the first communication includes a payload and a header and perform a first level filtering of the first communication, where the first level filtering includes filtering the header to determine an internet protocol (IP) address of a remote computing device of the first communication and to determine whether the IP address is associated with an approved remote computing device. In some embodiments, the logic causes the security infrastructure to perform a second level filtering of the first communication, where the second level filtering includes analysis of at least one of the following in the header: a transmission control protocol (TCP) port or a user datagram protocol (UDP) port, to determine whether the header identifies at least one of the following: an approved TCP port or an approved UDP port. In some embodiments, the logic causes the security infrastructure to perform a third level filtering of the first communication, where the third level filtering includes terminating transmission of the first communication and examining the first communication to determine whether the first communication includes malware. In some embodiments, the logic causes the security infrastructure to perform a fourth level filtering of the first communication, where the fourth level filtering includes maintaining legitimate session records and ensuring the first communication originated from a trusted data source. In some embodiments, the logic causes the system to perform a fifth level filtering of the first communication, where the fifth level filtering includes ensuring proper handling of the first communication toward the computing device. In some embodiments, the logic causes the security infrastructure, in response to determining that the first communication passes the first level filtering, the second level filtering, the third level filtering, the fourth level filtering, and the fifth level filtering, to pass the first communication to the computing device on the trusted network.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A depicts a computing environment that utilizes a single security device for a DMZ, according to embodiments provided herein;

FIG. 1B depicts a computing environment that utilizes a plurality of security devices for a DMZ, according to embodiments provided herein;

FIG. 2 depicts components of a security device for filtering network communications, according to embodiments described herein;

FIG. 3 depicts a flow diagram illustrating an open systems interconnection (OCI) layered model for filtering communications, according to embodiments described herein; and

FIG. 4 depicts a flowchart for filtering network communications with a demilitarized zone according to embodiments described herein.

### DETAILED DESCRIPTION

Embodiments disclosed herein include systems and methods for filtering network communications with a DMZ. Some embodiments include a DMZ network used as a gateway and security perimeter as a first line of defense to external connectivity. The DMZ may be configured to limit the communication to certain services and isolate the trusted network from external exposure and potential attacks.

Depending on the particular embodiment, the DMZ may be designed in a plurality of different ways, including using a screened subnet with single firewalling or using a screened subnet with dual firewalling. A simple DMZ may include firewalling capabilities, switching for basic networking and server for service hosting. More components can be added such as an intrusion detection/prevention system (IDS/IPS), a sandboxing solution, data diode for operational technology (OT), an industrial network, and/or application firewalling and web-email gateways.

Embodiments provided herein include a new structure of DMZ components to assure the healthiness and safe transmission and handling of the (outgoing/incoming) traffic. Specifically, these embodiments include five levels of defense, starting from layer 3 to layer 7 of the open systems interconnection (OSI) model.

The first level of defense includes a layer 3 inspection. For both incoming and outgoing traffic, the layer 3 inspection is the first line of defense. The layer 3 inspection is less intense compared the other layer inspections described below. The layer 3 inspection includes inspecting the header of the communication without deep analysis of the data. This can be performed by a router (such as with an access list), a firewall, denial of service (DoS) appliances, etc. As such, this first level inspection is performed without overwhelming network resources.

A second level of defense includes a layer 4 inspection. After inspection at layer 3 (IP address), a more granular inspection may take place at this layer where the communication will be inspected against layer 4 (TCP and/or UDP).

A third level of defense includes a layer 5 through layer 7 inspection. Unlike the other levels of defense, where the communication is inspected based on traffic-flow, at this third level, the communication is terminated to add an advanced, secured, and highly assured examination of the communication. As such, the payload is examined to assure the data is free of malware or attack. If the communication is encrypted (e.g., secure sockets layer (SSL)), at this third level, the traffic will be decrypted and examined before moving to next level. Since data is terminated, any of a plurality of solutions can be applied, such as in-plane switching (IPS), antivirus, sandboxing, web gateway analysis, email gateway analysis, cross-domain analysis, advanced DoS analysis, next generation firewalls, etc.

A fourth level of defense includes another layer 4 inspection. After inspection at layer 5-7 (application layer), more checks are applied at this level to maintain the legitimate session records and emphasis on trusted data source only. A fifth level of defense assures that there is proper handling of the traffic toward the destination and narrow down the inspection checks for the return traffic/sessions. Accordingly, the systems and methods for filtering network communications with a demilitarized zone incorporating the same will be described in more detail, below.

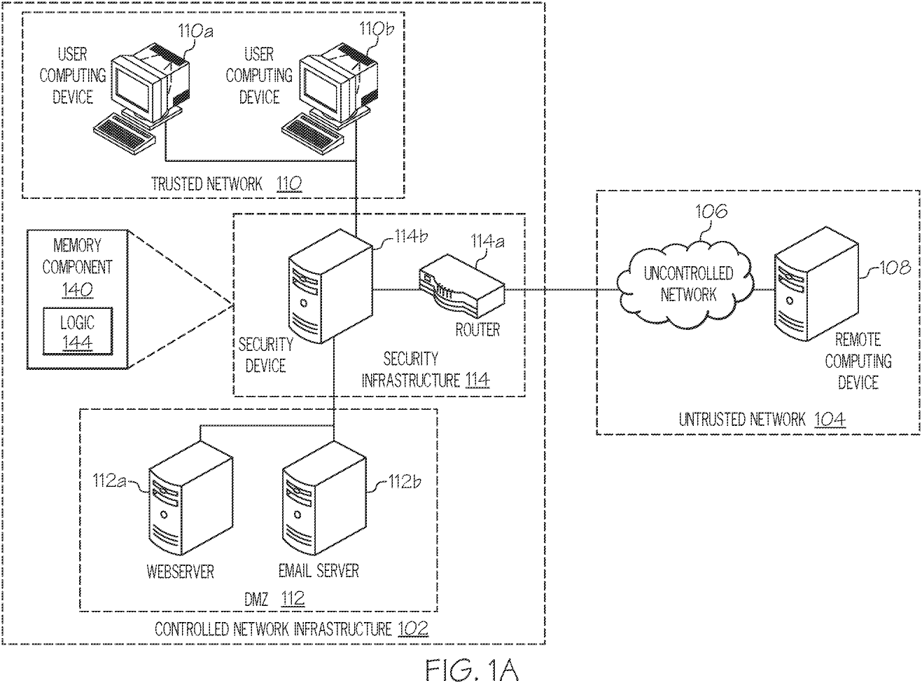

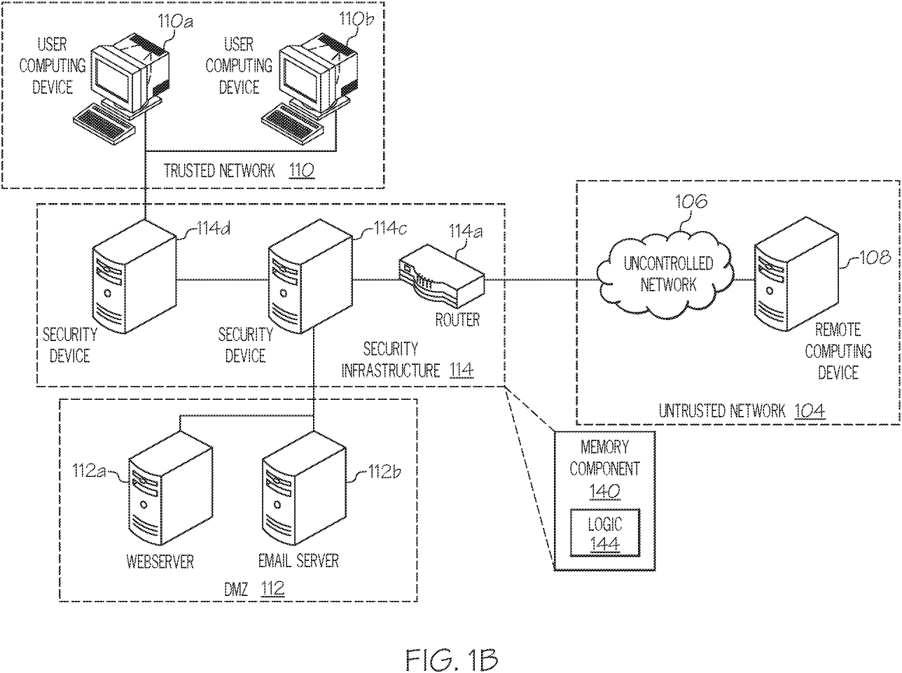

Referring now to the drawings, FIG. 1A depicts a computing environment that utilizes a security device 114b for a DMZ 112, according to embodiments provided herein. As illustrated, the computing environment may include a controlled network infrastructure 102 and an untrusted network 104.

The controlled network infrastructure 102 includes a trusted network 110 (which includes a first user computing device 110a and a second user computing device 110b), a DMZ 112, which includes one or more hosting device, such as a webserver 112a, and an email server 112b (such as a secure message transfer protocol (SMTP) device). Possible hosting devices may further include a voice over IP (VoIP) server, a file transfer protocol (FTP) server, etc.), and a security infrastructure 114 (which includes a router 114a and a security device 114b). As will be understood, the trusted network 110 may represent any set of computing devices, typically in a corporate, home, university, or government setting that are under the security of the controlled network infrastructure 102. While the first user computing device 110a and the second user computing device 110b are depicted, any number of computing devices may be part of the trusted network 110, limited only by the ability to maintain network and security integrity.

The user computing devices 110a, 110b may be coupled to the security infrastructure 114. The security infrastructure 114 may include a router 114a, as well as a security device 114b, such as a firewall, application security, antivirus security, etc. As will be understood, other security components may be included in the security infrastructure 114 to perform the functionality described herein.

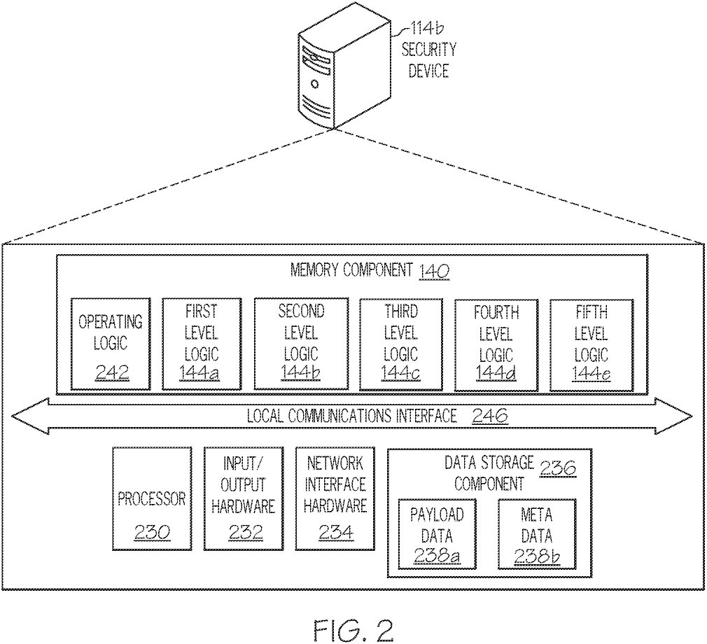

The security infrastructure 114 may also include a memory component 140 for storing logic 144. Specifically, one or more of the hardware components of the security infrastructure 114 (e.g., the router 114a, the security device 114b, and/or other hardware) may include a memory component, such as the memory component 140. Additionally, the logic 144, which is described in more detail with reference to FIG. 2, may represent one or more pieces of logic for performing the functionality provided herein.

The security infrastructure 114 may also be coupled to the DMZ 112. As discussed above, the DMZ 112 may include the webserver 112a, the email server 112b, and/or other hardware and software that connects to the untrusted network 104.

The untrusted network 104 may represent any combination of wide area networks (WAN), such as the internet, cellular network, etc., local area networks, peer-to-peer networks, and/or other network that is not fully under the control of the controlled network infrastructure 102. As such, the untrusted network 104 may be coupled to and/or include the remote computing device 108. The remote computing device 108 represents any computing device that is not part of the trusted network 110 or the DMZ 112 and thus may represent one or more computing devices. Stated another way, the remote computing device 108 represents any device that is not under the security or control of the controlled network infrastructure 102.

In operation, the remote computing device 108 may send a first communication intended for the first user computing device 110a. The first communication may include an email or other message, web page data, and/or other types of data, but typically includes a header and a payload. The first communication may be transmitted through the uncontrolled network 106 and may be received by the security infrastructure 114. The security infrastructure 114 may perform a preliminary analysis of the first communication and, based on that preliminary analysis, drop the first communication or send to the DMZ 112 for processing. The designated device in the DMZ 112 will process the first communication and send back to the security infrastructure 114 for further analysis. The security infrastructure 114 will then send to the first user computing device 110a in the trusted network 110.

Communications from one or more of the user computing devices 110a, 110b may follow a similar path, in reverse order. Specifically, a second communication from the second user computing device 110b may be created and sent to the security infrastructure 114. The security infrastructure 114 may analyze the second communication and, if acceptable, send to the DMZ 112. The DMZ 112 may process the communication, based on the type of data in the communication, and may send the second communication back to the security infrastructure 114 for further analysis. If acceptable, the security infrastructure 114 may send to the remote computing device 108 via the untrusted network 104.

FIG. 1B depicts a computing environment that utilizes a plurality of security devices 114c, 114d for a DMZ 112, according to embodiments provided herein. As illustrated, the computing environment of FIG. 1B is very similar to the computing environment of FIG. 1A, except that FIG. 1B depicts a first security device 114c and a second security device 114d.

In operation, the first security device 114c may receive a communication from the untrusted network 104 and send the communication to the DMZ 112. The second security device 114d may receive a communication from the DMZ 112 and communicate the communication to the trusted network 110. Specifically, the remote computing device 108 may create a first communication for sending to the first user computing device 110a. The security infrastructure 114 may receive the first communication at the router 114a and/or the first security device 114c. The first security device 114c may perform an analysis and/or filtering of the first communication and, if acceptable will send to the DMZ 112. One or more of the devices in the DMZ 112 may process the communication and send to the second security device 114d for further processing, analysis, and/or filtering. If acceptable, the second security device 114d may send to the user computing device 110a.

Communications originating from the trusted network 110 may be processed in the reverse order. Specifically, if the second user computing device 110b creates and sends a second communication intended for the remote computing device 108, the second communication may be first sent to the second security device 114d for filtering. If acceptable, the second security device 114d may send to the DMZ 112 for processing. The DMZ 112 may then send the second communication to the first security device 114c for further filtering. If acceptable, the first security device 114c may send to the remote computing device 108 via the untrusted network 104.

It should be understood that while the first security device 114c and the second security device 114d may be configured as illustrated in FIG. 1B, this is one example. Some embodiments may utilize a sandwich design, with an outer security device and an inner security device. The outer security device may be configured to secure the DMZ 112 from the uncontrolled network 106. The inner security device may add an additional layer of security between the devices in the DMZ 112 and the trusted network 110.

FIG. 2 depicts components of a security device 114b for filtering network communications, according to embodiments described herein. As illustrated, the security device 114b includes a processor 230, input/output hardware 232, a network interface hardware 234, a data storage component 236 (which stores payload data 238a, metadata 238b, and/or other data), and a memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable mediums. Depending on the particular embodiment, these non-transitory computer-readable mediums may reside within the security device 114b and/or external to the security device 114b.

The memory component 140 may store operating logic 242, first level logic 144a, second level logic 144b, third level logic 144c, fourth level logic 144d, and fifth level logic 144e. Each of these logic components may include a plurality of different pieces of logic, each of which may be embodied as a computer program, firmware, and/or hardware, as an example. A local interface 246 is also included in FIG. 2 and may be implemented as a bus or other communication interface to facilitate communication among the components of the security device 114b.

The processor 230 may include any processing component operable to receive and execute instructions (such as from a data storage component 236 and/or the memory component 140). As described above, the input/output hardware 232 may include and/or be configured to interface with input/output components.

The network interface hardware 234 may include and/or be configured for communicating with any wired or wireless networking hardware, including an antenna, a modem, a LAN port, wireless fidelity (Wi-Fi) card, WiMAX card, mobile communications hardware, and/or other hardware for communicating with other networks and/or devices. From this connection, communication may be facilitated between the security device 114b and other computing devices.

The operating logic 242 may include an operating system and/or other software for managing components of the security device 114b. As discussed above, the first level logic 144a may reside in the memory component 140 and may be configured to cause the processor 230 to perform the first level communication filtering, as described below. The second level logic 144b may be configured to cause the processor 230 to perform the second level communication filtering. The third level logic 144c may be configured to cause the processor 230 to perform the third level communication filtering. The fourth level logic 144d may be configured to cause the processor 230 to perform the fourth level communication filtering. The fifth level logic 144e may be configured to cause the processor 230 to perform the fifth level communication filtering.

It should be understood that while the components in FIG. 2 are illustrated as residing within the security device 114b, this is merely an example. In some embodiments, one or more of the components may reside external to the security device 114b or within other devices. It should also be understood that, while the security device 114b is illustrated as a single device, this is also merely an example. In some embodiments, the first level logic 144a, the second level logic 144b, the third level logic 144c, the fourth level logic 144d, and the fifth level logic 144e may reside on different devices.

Additionally, while the security device 114b is illustrated with the first level logic 144a, the second level logic 144b, the third level logic 144c, the fourth level logic 144d, and the fifth level logic 144e as separate logical components, this is also an example. In some embodiments, a single piece of logic may provide the described functionality. It should also be understood that while the first level logic 144a, the second level logic 144b, the third level logic 144c, the fourth level logic 144d, and the fifth level logic 144e are described herein as the logical components, this is also an example. Other components may also be included, depending on the embodiment.

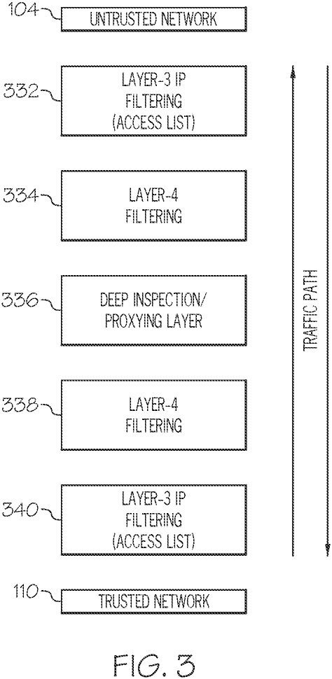

FIG. 3 depicts a flow diagram illustrating an open systems interconnection (OCI) layered model for filtering communications, according to embodiments described herein. As illustrated, a computing device on the untrusted network 104 may send a communication directed to a computing device on the trusted network 110. Accordingly, the security infrastructure 114 may perform first level filtering at block 332, which includes a layer 3 inspection. The layer 3 filtering includes inspecting the header of the communication for an originating IP address. This can be performed by the router 114a (such as by comparing the IP address to a whitelist of approved IP addresses), a firewall, a DoS appliance, etc.

At block 334, a layer 4 filtering is performed by the security infrastructure 114. The layer 4 filtering is a granular inspection of the TCP/UDP ports identified in the communication. At block 336, a layer 5-7 filtering is performed, which includes a deep inspection of the communication. In this filtering, the transmission of the communication is terminated to perform a thorough examination of the payload portion of the communication for malware or other attack. If the communication is encrypted, the communication will be decrypted and examined before moving to next level. Since transmission of the communication is terminated, any of a plurality of filtering can be applied to the communication, such as IPS, antivirus, sandboxing, web gateway analysis, email gateway analysis, cross-domain analysis, advanced DoS analysis, next generation firewalls, etc.

At block 338, another layer 4 inspection is performed to maintain the legitimate session records, placing an emphasis on trusted data sources only. At block 340, another layer 3 filtering is performed to ensure that there is proper handling of the traffic toward the destination and narrow down the inspection checks for the return traffic/sessions. If the communication is acceptable through the five layers of filtering, the communication may be communicated to the computing device in the trusted network 110.

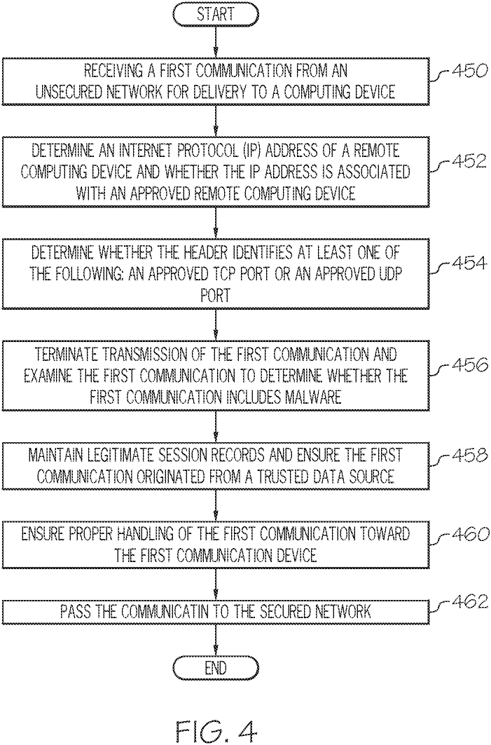

FIG. 4 depicts a flowchart for filtering network communications with a demilitarized zone according to embodiments described herein. As illustrated in block 450, a first communication may be received from an untrusted network 104 for delivery to a computing device on a trusted network 110. The first communication may include a payload and a header. In block 452, a first level filtering of the first communication may be performed. The first level filtering may include a first open systems interconnection (OSI) layer 3 filtering of the header to determine an internet protocol (IP) address of a remote computing device 108 of the first communication and determine whether the IP address is associated with an approved remote computing device 108.

At block 454, a second level filtering of the first communication may be performed. The second level filtering includes a first OSI layer 4 analysis of a transmission control protocol (TCP) port and/or a user datagram protocol (UDP) port in the header. This may be performed to determine whether the header identifies an approved TCP port and/or an approved UDP port. In block 456, a third level filtering of the first communication may be performed. The third level filtering may include an OSI layer 5 through layer 7 inspection. At this third level, transmission of the first communication may be terminated and the payload of the first communication may be examined to determine whether the first communication includes malware.

At block 458, a fourth level filtering of the first communication may be performed. The fourth level filtering includes a second OSI layer 4 analysis, and is configured to maintain legitimate session records and ensuring the first communication originated from a trusted data source. At block 460, a fifth level filtering of the first communication may be performed. The fifth level filtering includes a second OSI layer 3 filtering, and includes ensuring proper handling of the first communication toward the first computing device. At block 462, in response to determining that the first communication passes the first level filtering, the second level filtering, the third level filtering, the fourth level filtering, and the fifth level filtering, the first communication is passed to the computing device on the trusted network 110.

Various aspects for filtering network communication with a DMZ are disclosed. Specifically, a first aspect includes a method for filtering data network communications using a demilitarized zone (DMZ), comprising: receiving a first communication from an untrusted network for delivery to a computing device on a trusted network, wherein the first communication includes a payload and a header; performing a first level filtering of the first communication, wherein the first level filtering includes a first open systems interconnection (OSI) layer 3 filtering of the header to determine an internet protocol (IP) address of a remote computing device of the first communication and to determine whether the IP address is associated with an approved remote computing device; performing a second level filtering of the first communication, wherein the second level filtering includes a first OSI layer 4 analysis of at least one of the following in the header: a transmission control protocol (TCP) port or a user datagram protocol (UDP) port, to determine whether the header identifies at least one of the following: an approved TCP port or an approved UDP port; performing a third level filtering of the first communication, wherein the third level filtering includes an OSI layer 5 through layer 7 inspection, wherein the third level filtering includes terminating transmission of the first communication and examining the first communication to determine whether the first communication includes malware; performing a fourth level filtering of the first communication, wherein the fourth level filtering includes a second OSI layer 4 analysis, wherein the fourth level filtering includes maintaining legitimate session records and ensuring the first communication originated from a trusted data source; performing a fifth level filtering of the first communication, wherein the fifth level filtering includes a second OSI layer 3 filtering, wherein the fifth level filtering includes ensuring proper handling of the first communication toward the computing device; and in response to determining that the first communication passes the first level filtering, the second level filtering, the third level filtering, the fourth level filtering, and the fifth level filtering, passing the first communication to the computing device on the trusted network.

A second aspect includes the first aspect, further comprising, in response to determining that the first communication does not pass at least one of the following: the first level filtering, the second level filtering, the third level filtering, the fourth level filtering, or the fifth level filtering, preventing the first communication from entering the trusted network.

A third aspect includes the first and/or second aspect, wherein the third level of filtering includes decrypting the payload.

A fourth aspect includes any of the first aspect through the third aspect, wherein the first communication includes at least one of the following, an email, a voice over IP (VoIP) request, a file transfer protocol (FTP) request, or an internet packet.

A fifth aspect includes any of the first aspect through the fourth aspect, wherein the first level of filtering includes comparing the IP address with a whitelist of approved IP addresses.

A sixth aspect includes any of the first aspect through the fifth aspect, wherein the third level of filtering includes at least one of the following: in-plane switching (IPS), antivirus analysis, sandboxing, web gateway analysis, email gateway analysis, cross-domain solution analysis, advanced denial of service (DoS) analysis, or a next generation firewall.

A seventh aspect includes any of the first aspect through the sixth aspect, further comprising: receiving a second communication from the computing device on the trusted network; performing the fifth level of filtering to the second communication; performing the fourth level of filtering to the second communication; performing the third level of filtering to the second communication; performing the second level of filtering to the second communication; performing the first level of filtering to the second communication; and in response to determining that the second communication passes the first level filtering, the second level filtering, the third level filtering, the fourth level filtering, and the fifth level filtering, passing the second communication to the remote computing device on the untrusted network.

An eighth aspect includes system for filtering data network communications using a demilitarized zone (DMZ), comprising: a trusted network that includes a computing device; a DMZ that includes a hosting device; and security infrastructure that includes logic, that when executed by a processor, causes the security infrastructure to perform at least the following: receive a first communication from an untrusted network for delivery to the computing device on the trusted network, wherein the first communication includes a payload and a header; perform a first level filtering of the first communication, wherein the first level filtering includes a first open systems interconnection (OSI) layer 3 filtering of the header to determine an internet protocol (IP) address of a remote computing device of the first communication and to determine whether the IP address is associated with an approved remote computing device; perform a second level filtering of the first communication, wherein the second level filtering includes a first OSI layer 4 analysis of at least one of the following in the header: a transmission control protocol (TCP) port or a user datagram protocol (UDP) port, to determine whether the header identifies at least one of the following: an approved TCP port or an approved UDP port; perform a third level filtering of the first communication, wherein the third level filtering includes an OSI layer 5 through layer 7 inspection, wherein the third level filtering includes terminating transmission of the first communication and examining the first communication to determine whether the first communication includes malware; perform a fourth level filtering of the first communication, wherein the fourth level filtering includes a second OSI layer 4 analysis, wherein the fourth level filtering includes maintaining legitimate session records and ensuring the first communication originated from a trusted data source; perform a fifth level filtering of the first communication, wherein the fifth level filtering includes a second OSI layer 3 filtering, wherein the fifth level filtering includes ensuring proper handling of the first communication toward the computing device; and in response to determining that the first communication passes the first level filtering, the second level filtering, the third level filtering, the fourth level filtering, and the fifth level filtering, pass the first communication to the computing device on the trusted network.

A ninth aspect includes the eighth aspect, wherein the security infrastructure includes a single security device for performing the first level filtering, the second level filtering, the third level filtering, the fourth level filtering, and the fifth level filtering.

A tenth aspect includes the eighth aspect and/or the ninth aspect, wherein the security infrastructure includes a plurality of security devices for performing the first level filtering, the second level filtering, the third level filtering, the fourth level filtering, and the fifth level filtering.

An eleventh aspect includes any of the eighth aspect through the tenth aspect, wherein the logic further causes the system, in response to determining that the first communication does not pass at least one of the following: the first level filtering, the second level filtering, the third level filtering, the fourth level filtering, or the fifth level filtering, to prevent the first communication from entering the trusted network.

A twelfth aspect includes any of the eighth aspect through the eleventh aspect, wherein the third level of filtering includes decrypting the payload.

A thirteenth aspect includes any of the eighth aspect through the twelfth aspect, wherein the first communication includes at least one of the following, an email, a voice over IP (VoIP) request, a file transfer protocol (FTP) request, or an internet packet.

A fourteenth aspect includes any of the eighth aspect through the thirteenth aspect, wherein the hosting device of the DMZ includes at least one of the following: an email server, a voice over IP (VoIP) server, a file transfer protocol (FTP) server, or a web server.

A fifteenth aspect includes any of the eighth aspect through the fourteenth aspect, wherein the first level of filtering includes comparing the IP address with a whitelist of approved IP addresses.

A sixteenth aspect includes any of the eighth aspect through the fifteenth aspect, wherein the third level of filtering includes at least one of the following: in-plane switching (IPS), antivirus analysis, sandboxing, web gateway analysis, email gateway analysis, cross-domain solution analysis, advanced denial of service (DoS) analysis, or a next generation firewall.

A seventeenth aspect includes any of the eighth aspect through the sixteenth aspect, wherein the logic further causes the system to perform at least the following: receive a second communication from the computing device on the trusted network; perform the fifth level of filtering to the second communication; perform the fourth level of filtering to the second communication; perform the third level of filtering to the second communication; perform the second level of filtering to the second communication; perform the first level of filtering to the second communication; and in response to determining that the second communication passes the first level filtering, the second level filtering, the third level filtering, the fourth level filtering, and the fifth level filtering, pass the second communication to the remote computing device on the untrusted network.

An eighteenth aspect a system for filtering data network communications using a demilitarized zone (DMZ), comprising: security infrastructure that includes logic, that when executed by a processor, causes the security infrastructure to perform at least the following: receive a first communication from an untrusted network for delivery to a computing device on a trusted network, wherein the first communication includes a payload and a header; perform a first level filtering of the first communication, wherein the first level filtering includes filtering the header to determine an internet protocol (IP) address of a remote computing device of the first communication and to determine whether the IP address is associated with an approved remote computing device; perform a second level filtering of the first communication, wherein the second level filtering includes analysis of at least one of the following in the header: a transmission control protocol (TCP) port or a user datagram protocol (UDP) port, to determine whether the header identifies at least one of the following: an approved TCP port or an approved UDP port; perform a third level filtering of the first communication, wherein the third level filtering includes terminating transmission of the first communication and examining the first communication to determine whether the first communication includes malware; perform a fourth level filtering of the first communication, wherein the fourth level filtering includes maintaining legitimate session records and ensuring the first communication originated from a trusted data source; perform a fifth level filtering of the first communication, wherein the fifth level filtering includes ensuring proper handling of the first communication toward the computing device; and in response to determining that the first communication passes the first level filtering, the second level filtering, the third level filtering, the fourth level filtering, and the fifth level filtering, pass the first communication to the computing device on the trusted network.

A nineteenth aspect that includes the eighteenth aspect, further comprising: the trusted network that includes the computing device; and the DMZ that includes a hosting device.

A twentieth aspect includes the eighteenth aspect and/or the nineteenth aspect, wherein the logic further causes the system to perform at least the following: receive a second communication from the computing device on the trusted network; perform the fifth level of filtering to the second communication; perform the fourth level of filtering to the second communication; perform the third level of filtering to the second communication; perform the second level of filtering to the second communication; perform the first level of filtering to the second communication; and in response to determining that the second communication passes the first level filtering, the second level filtering, the third level filtering, the fourth level filtering, and the fifth level filtering, pass the second communication to the remote computing device on the untrusted network.

As illustrated above, various embodiments for filtering network communications with a demilitarized zone are disclosed. These embodiments may be configured to provide increased network security using a DMZ. These embodiments may also be configured to operate in different DMZ environments, thus allowing for expanded functionality of the increased security.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for filtering network communications with a demilitarized zone. It should also be understood that these embodiments are merely exemplary and are not intended to limit the scope of this disclosure.

What is claimed is:

1. A method for filtering data network communications using a demilitarized zone (DMZ), comprising:
receiving a first communication from an untrusted network for delivery to a computing device on a trusted network, wherein the first communication includes a payload and a header;
performing a first level filtering of the first communication, wherein the first level filtering includes a first open systems interconnection (OSI) layer 3 filtering of the header to determine an internet protocol (IP) address of a remote computing device of the first communication and to determine whether the IP address is associated with an approved remote computing device;
performing a second level filtering of the first communication, wherein the second level filtering includes a first OSI layer 4 analysis of at least one of the following in the header: a transmission control protocol (TCP) port or a user datagram protocol (UDP) port, to determine whether the header identifies at least one of the following: an approved TCP port or an approved UDP port;
performing a third level filtering of the first communication, wherein the third level filtering includes an OSI layer 5 through layer 7 inspection, wherein the third level filtering includes terminating transmission of the first communication and examining the first communication to determine whether the first communication includes malware;
performing a fourth level filtering of the first communication, wherein the fourth level filtering includes a second OSI layer 4 analysis, wherein the fourth level filtering includes maintaining legitimate session records and ensuring the first communication originated from a trusted data source;
performing a fifth level filtering of the first communication, wherein the fifth level filtering includes a second OSI layer 3 filtering, wherein the fifth level filtering includes ensuring proper handling of the first communication toward the computing device; and
in response to determining that the first communication passes the first level filtering, the second level filtering, the third level filtering, the fourth level filtering, and the fifth level filtering, passing the first communication to the computing device on the trusted network.

2. The method of claim 1, further comprising, in response to determining that the first communication does not pass at least one of the following: the first level filtering, the second level filtering, the third level filtering, the fourth level filtering, or the fifth level filtering, preventing the first communication from entering the trusted network.

3. The method of claim 1, wherein the third level of filtering includes decrypting the payload.

4. The method of claim 1, wherein the first communication includes at least one of the following, an email, a voice over IP (VoIP) request, a file transfer protocol (FTP) request, or an internet packet.

5. The method of claim 1, wherein the first level of filtering includes comparing the IP address with a whitelist of approved IP addresses.

6. The method of claim 1, wherein the third level of filtering includes at least one of the following: in-plane switching (IPS), antivirus analysis, sandboxing, web gateway analysis, email gateway analysis, cross-domain solution analysis, advanced denial of service (DoS) analysis, or a next generation firewall.

7. The method of claim 1, further comprising:
receiving a second communication from the computing device on the trusted network;
performing the fifth level of filtering to the second communication;
performing the fourth level of filtering to the second communication;
performing the third level of filtering to the second communication;
performing the second level of filtering to the second communication;
performing the first level of filtering to the second communication; and
in response to determining that the second communication passes the first level filtering, the second level filtering, the third level filtering, the fourth level filtering, and the fifth level filtering, passing the second communication to the remote computing device on the untrusted network.

8. A system for filtering data network communications using a demilitarized zone (DMZ), comprising:
a trusted network that includes a computing device;
a DMZ that includes a hosting device; and
security infrastructure that includes logic, that when executed by a processor, causes the security infrastructure to perform at least the following:
receive a first communication from an untrusted network for delivery to the computing device on the trusted network, wherein the first communication includes a payload and a header;
perform a first level filtering of the first communication, wherein the first level filtering includes a first open systems interconnection (OSI) layer 3 filtering of the header to determine an internet protocol (IP) address of a remote computing device of the first communication and to determine whether the IP address is associated with an approved remote computing device;
perform a second level filtering of the first communication, wherein the second level filtering includes a first OSI layer 4 analysis of at least one of the following in the header: a transmission control protocol (TCP) port or a user datagram protocol (UDP) port, to determine whether the header identifies at least one of the following: an approved TCP port or an approved UDP port;
perform a third level filtering of the first communication, wherein the third level filtering includes an OSI layer 5 through layer 7 inspection, wherein the third level filtering includes terminating transmission of the first communication and examining the first communication to determine whether the first communication includes malware;
perform a fourth level filtering of the first communication, wherein the fourth level filtering includes a second OSI layer 4 analysis, wherein the fourth level filtering includes maintaining legitimate session records and ensuring the first communication originated from a trusted data source;
perform a fifth level filtering of the first communication, wherein the fifth level filtering includes a second OSI layer 3 filtering, wherein the fifth level filtering includes ensuring proper handling of the first communication toward the computing device; and
in response to determining that the first communication passes the first level filtering, the second level filtering, the third level filtering, the fourth level filtering, and the fifth level filtering, pass the first communication to the computing device on the trusted network.

9. The system of claim 8, wherein the security infrastructure includes a single security device for performing the first level filtering, the second level filtering, the third level filtering, the fourth level filtering, and the fifth level filtering.

10. The system of claim 9, wherein the security infrastructure includes a plurality of security devices for performing the first level filtering, the second level filtering, the third level filtering, the fourth level filtering, and the fifth level filtering.

11. The system of claim 8, wherein the logic further causes the system, in response to determining that the first communication does not pass at least one of the following: the first level filtering, the second level filtering, the third level filtering, the fourth level filtering, or the fifth level filtering, to prevent the first communication from entering the trusted network.

12. The system of claim 8, wherein the third level of filtering includes decrypting the payload.

13. The system of claim 8, wherein the first communication includes at least one of the following, an email, a voice over IP (VoIP) request, a file transfer protocol (FTP) request, or an internet packet.

14. The system of claim 8, wherein the hosting device of the DMZ includes at least one of the following: an email server, a voice over IP (VoIP) server, a file transfer protocol (FTP) server, or a web server.

15. The system of claim 8, wherein the first level of filtering includes comparing the IP address with a whitelist of approved IP addresses.

16. The system of claim 8, wherein the third level of filtering includes at least one of the following: in-plane switching (IPS), antivirus analysis, sandboxing, web gateway analysis, email gateway analysis, cross-domain solution analysis, advanced denial of service (DoS) analysis, or a next generation firewall.

17. The system of claim 8, wherein the logic further causes the system to perform at least the following:
receive a second communication from the computing device on the trusted network;
perform the fifth level of filtering to the second communication;
perform the fourth level of filtering to the second communication;
perform the third level of filtering to the second communication;
perform the second level of filtering to the second communication;
perform the first level of filtering to the second communication; and
in response to determining that the second communication passes the first level filtering, the second level filtering, the third level filtering, the fourth level filtering, and the fifth level filtering, pass the second communication to the remote computing device on the untrusted network.

18. A system for filtering data network communications using a demilitarized zone (DMZ), comprising:
security infrastructure that includes logic, that when executed by a processor, causes the security infrastructure to perform at least the following:
receive a first communication from an untrusted network for delivery to a computing device on a trusted network, wherein the first communication includes a payload and a header;
perform a first level filtering of the first communication, wherein the first level filtering includes filtering the header to determine an internet protocol (IP) address of a remote computing device of the first communication and to determine whether the IP address is associated with an approved remote computing device;
perform a second level filtering of the first communication, wherein the second level filtering includes analysis of at least one of the following in the header: a transmission control protocol (TCP) port or a user datagram protocol (UDP) port, to determine whether the header identifies at least one of the following: an approved TCP port or an approved UDP port;
perform a third level filtering of the first communication, wherein the third level filtering includes terminating transmission of the first communication and examining the first communication to determine whether the first communication includes malware;
perform a fourth level filtering of the first communication, wherein the fourth level filtering includes maintaining legitimate session records and ensuring the first communication originated from a trusted data source;
perform a fifth level filtering of the first communication, wherein the fifth level filtering includes ensuring proper handling of the first communication toward the computing device; and
in response to determining that the first communication passes the first level filtering, the second level filtering, the third level filtering, the fourth level filtering, and the fifth level filtering, pass the first communication to the computing device on the trusted network.

19. The system of claim 18, further comprising:
the trusted network that includes the computing device; and
the DMZ that includes a hosting device.

20. The system of claim 18, wherein the logic further causes the system to perform at least the following:
receive a second communication from the computing device on the trusted network;
perform the fifth level of filtering to the second communication;
perform the fourth level of filtering to the second communication;
perform the third level of filtering to the second communication;
perform the second level of filtering to the second communication;
perform the first level of filtering to the second communication; and
in response to determining that the second communication passes the first level filtering, the second level filtering, the third level filtering, the fourth level filtering, and the fifth level filtering, pass the second communication to the remote computing device on the untrusted network.
